(19) United States
(12) Patent Application Publication
(10) Pub. No.: US 2024/0117935 A1
(43) Pub. Date: Apr. 11, 2024

(54) PRESSURIZED GAS CONTAINMENT LINER, PRESSURIZED GAS TANK AND METHOD FOR MANUFACTURING AN ASSOCIATED PRESSURIZED GAS CONTAINMENT LINER

(71) Applicant: FAURECIA SYSTEMES D'ECHAPPEMENT, Nanterre (FR)

(72) Inventors: Christophe BAVEREL, AUDINCOURT (FR); Dorian HERNANDEZ, JONCHEREY (FR); David FARALDI, MONTBELIARD (FR); Marc MORET, LA CHAPELLE SUR ERDRE (FR); Thomas BRANGER, MONTAIGU (FR)

(21) Appl. No.: 18/375,652

(22) Filed: Oct. 2, 2023

(30) Foreign Application Priority Data
Oct. 5, 2022 (FR) 22 10194

(51) Int. Cl. F17C 1/16

(52) U.S. Cl. CPC F17C 1/16; F17C 2201/0147; F17C 2203/013; F17C 2203/0604; F17C 2203/066; F17C 2203/0673; F17C 2209/22; F17C 2221/012; F17C 2223/036; F17C 2270/0178; F17C 2270/0184

(57) ABSTRACT

A pressurized gas containment liner includes a first part comprising a first shell with a first peripheral edge, and a second part comprising a second shell with a second peripheral edge. The first peripheral edge is rigidly connected to the second peripheral edge, and the first shell and the second shell delimit between them an interior volume. The first part comprises at least one pillar that passes through the interior volume, is formed integrally with the first shell, and is elongated between a proximal end, connected to the first shell, and a distal end, rigidly connected to the second part. A transverse section of the pillar decreases from the proximal end to the distal end.

### CROSS-REFERENCE TO RELATED APPLICATION

This application is a U.S. non-provisional application claiming the benefit of French Application No. 22 10194, filed on Oct. 5, 2022, which is incorporated herein by reference in its entirety.

### TECHNICAL FIELD

The present disclosure relates to a pressurized gas containment liner. The disclosure relates to a pressurized gas tank comprising such a liner as well as a method for manufacturing such a liner.

### BACKGROUND

In the field of transport means, and in particular in automotive transport, it may prove important to contain pressurized gas. This proves all the more true with the growth of vehicles provided with fuel cells, for which dihydrogen intended to supply a fuel cell must be stored in the vehicle.

It is known to use cylindrical tanks for the containment of pressurized gas in vehicles. Such tanks are generally provided with a cylindrical compression liner, arranged inside a body of the tank, and aiming to ensure the containment of the pressurized gas within the tank.

Such liners, and more generally such tanks, however, are not entirely satisfactory due to their shape which is sometimes unsuitable for the layout of a vehicle.

It has therefore been proposed to use non-cylindrical reservoirs, for example prismatic tanks. Such tanks generally have the shape of a flattened prism, making it possible to improve the integration of the tank in the vehicle.

However, such tanks are not entirely satisfactory. Specifically, it has been shown that due to their non-cylindrical shape, the tanks are less robust. It has then been necessary to reinforce the tanks locally in order to improve their robustness, and to adapt the liners to such reinforcements. However, the manufacture of such liners has proven complex.

Thus, one of the aims of the disclosure is to propose a gas containment liner allowing easier integration into a vehicle while being inexpensive to manufacture and making it possible to obtain a robust tank.

### SUMMARY

To this end, the disclosure relates to a pressurized gas containment liner, comprising:
a first part, comprising a first shell comprising a first peripheral edge,
a second part, comprising a second shell comprising a second peripheral edge,
the first peripheral edge being rigidly connected to the second peripheral edge, the first shell and the second shell delimiting between them an interior volume, the first part comprising at least one pillar passing through the interior volume, formed integrally with the first shell and being elongated between a proximal end, connected to the first shell, and a distal end, rigidly connected to the second part, a transverse section of the pillar decreasing from its proximal end to its distal end.

The use of a first part comprising at least one pillar makes it possible to obtain a pressurized gas containment liner able to accommodate reinforcement elements, thus making it possible to obtain a tank whose robustness is improved. The decreasing cross-section of the pillar from its proximal end to its distal end is also particularly advantageous for the production of the first part, for example by molding, such a geometry facilitating the demolding of the first part following its manufacture.

According to other advantageous aspects of the disclosure, the pressurized gas containment liner comprises several of the following features, taken alone or in any technically feasible combination:
the pillar is hollow, the pillar comprising a pillar wall connected to the first shell and delimiting a pillar cavity;
the pillar wall extends in the continuity of the first shell, the first shell and the pillar delimiting a first opening emptying into the pillar cavity, the second shell and the pillar delimiting a second opening opposite the first opening relative to the pillar, the second opening emptying into the pillar cavity;
a thickness of the pillar wall is substantially equal to a thickness of the first shell;
the first peripheral edge is rigidly connected to the second peripheral edge along a junction plane, the pillar passing through the junction plane;
the second part comprises at least one receiving seat, carried by the second shell, the pillar being received in the receiving seat and rigidly connected to the second part by the receiving seat;
one of the first and second peripheral edges extends around the other of the first and second peripheral edges into an overlapping region;
one of the first and second parts is formed of a material configured to be transparent to laser radiation, the other of the first and second parts being formed of a material configured to absorb the laser radiation, the first peripheral edge and the second peripheral edge and/or the pillar and the second part being rigidly connected to each other by laser welding;
the first peripheral edge and the second peripheral edge and/or the pillar and the second part are rigidly connected together by butt welding, a resistive sheet being arranged between adjacent edges welded to the first peripheral edge and the second peripheral edge and/or the pillar and the second part;
the adjacent edges delimit between them an oblique butt welding plane, extending obliquely relative to a direction of thickness of the first peripheral edge and of the second peripheral edge and/or of the pillar and of the second part;
the second part comprises at least one pillar passing through the interior volume, integrally formed with the second shell and being elongated between a proximal end, connected to the second shell, and a distal end, rigidly connected to the first part, a cross-section of the pillar decreasing from its proximal end to its distal end; and
the first and the second parts are substantially of the same shape.

The disclosure further relates to a pressurized gas tank comprising a pressurized gas containment liner as mentioned above, and a tank body arranged around the pressurized gas containment liner, an internal face of the tank body being affixed to an external face of the pressurized gas containment liner.

The disclosure further relates to a method for manufacturing a pressurized gas containment liner as mentioned above, comprising the following steps:
providing a first part and a second part of the shell;
rigidly connecting the first peripheral edge to the second peripheral edge and rigidly connecting the pillar of the first part to the second part.

### BRIEF DESCRIPTION OF THE DRAWINGS

The disclosure will be better understood on reading the following description, given solely by way of non-limiting example, and referring to the drawings in which:

FIG. 1 is a partial perspective view of a tank comprising a liner according to the disclosure;

FIG. 2 is a cross-sectional view of the tank of FIG. 1 along a cutting plane I-I;

FIG. 3 is a cross-sectional view similar to that of FIG. 2, wherein the tank comprises a liner according to an alternative to the liner of the tank of FIGS. 1 and 2;

FIG. 4 is a perspective view of the tank of FIGS. 1 and 2 in its entirety; and

FIG. 5 is a sectional view along the plane I-I of a detail of the rigid connection between two parts of a liner according to an alternative embodiment to the variants shown in FIGS. 1 to 4.

### DETAILED DESCRIPTION

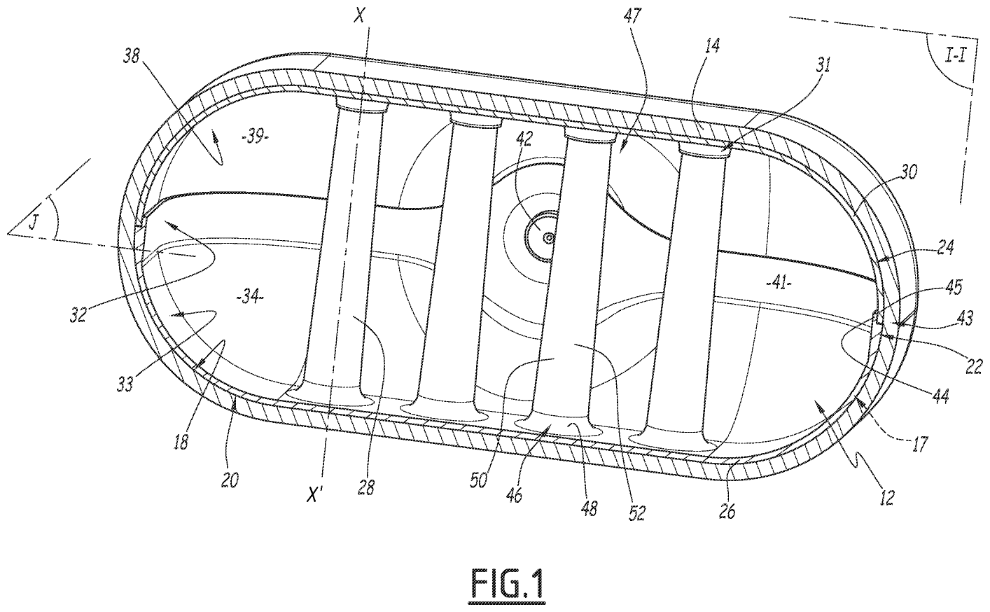

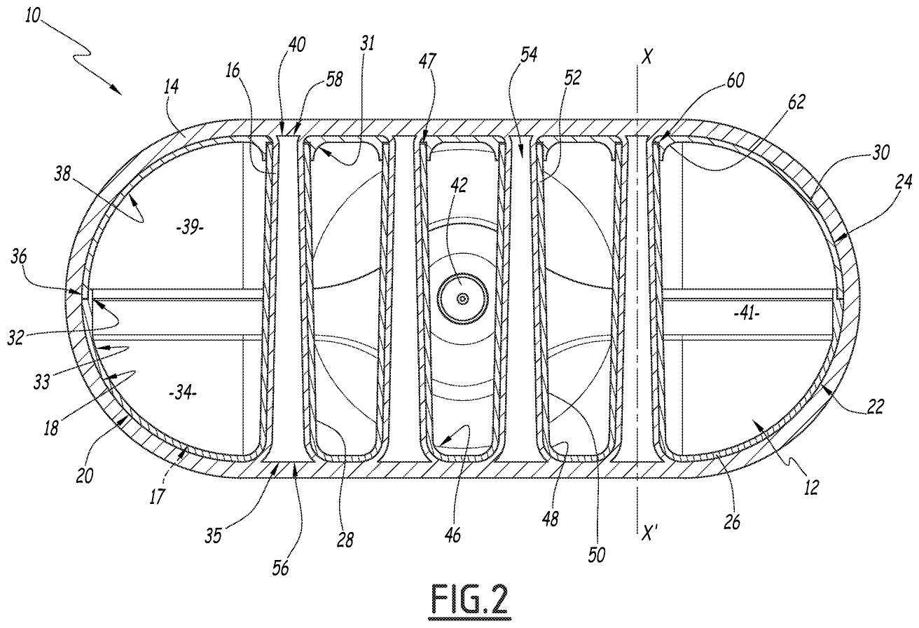

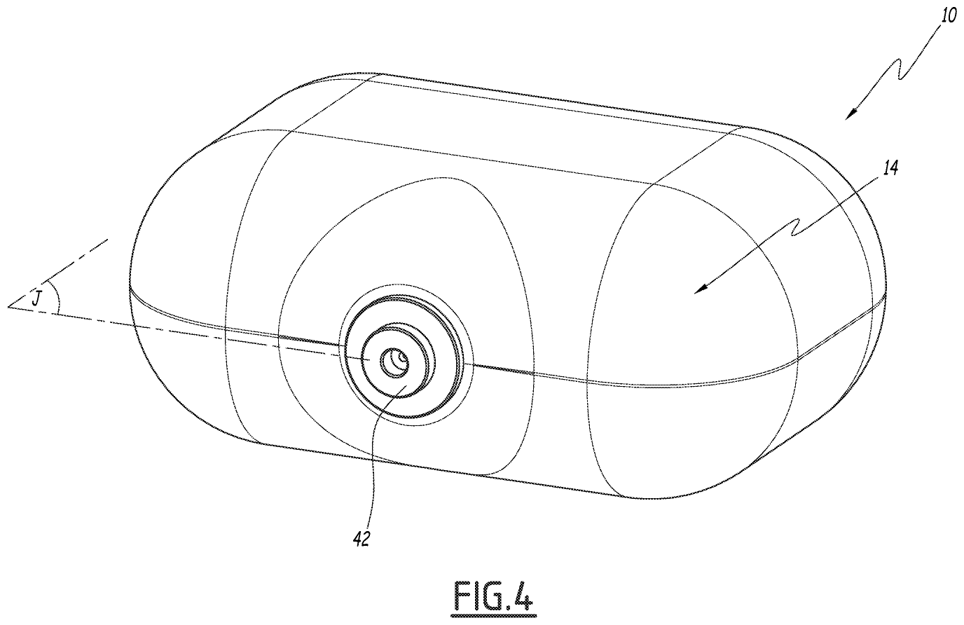

With reference to FIGS. 1 to 2 and 4, a pressurized gas tank 10 comprises a pressurized gas containment liner 12. As can be seen in FIG. 2, the tank 10 further comprises a tank body 14 as well as at least one tank column 16.

The pressurized gas tank 10 is configured to contain a pressurized gas such as, for example, a reducing fuel gas and such as in particular pressurized hydrogen. The tank of pressurized gas 10 is, for example, configured to contain a gas at a pressure greater than 200 bar and, for example, a gas at a pressure of 350 bar or a gas at a pressure of 700 bar. The pressurized gas tank 10 is further, for example, configured to contain a liquid, such as a liquid phase of the pressurized gas contained in the tank 10, for example.

The tank of pressurized gas 10 is, for example, intended to be installed in a vehicle, for example a motor vehicle. The pressurized gas tank 10 is, for example, configured to supply fuel to a fuel cell of the vehicle (not shown).

The tank body 14, for example, forms a body volume 17 in which the liner 12 is housed. The tank body 14 comprises, for example, an inner face 18 defining the body volume 17. The tank body 14 is, for example, produced around the liner 12 so that the liner 12 is arranged in the tank body 14, the internal face 18 being, for example, affixed to an external face 20 of the liner.

The tank body 14 is, for example, made from composite. The composite from which the tank body 14 is made comprises, for example, a resin such as: an epoxy resin, or a resin made from at least one thermoplastic polymer selected from the group consisting of polyolefins, in particular polypropylene, polyamides, in particular aliphatic polyamides, such as polycaprolactam PA 6, polyhexamethylene adipamide PA 6.6, polycarbonates, PAEK (polyaryletherketone), including PEEK (polyetheretherketone) and PEKK (polyetherketoneketone), acrylic-based materials such as PMMA (including the resin known as ELIUM), PEI (Polyetherimide also known as ULTEM), PPS (Polyphenylene Sulfide), ABS (Acrylonitrile Butadiene Styrene), PLA (Polylactic Acid), TPU (Thermoplastic Polyurethane) and PET (Polyethylene), and mixtures thereof.

The composite from which the tank body 14 is made comprises, for example, a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers.

As can be seen in FIG. 2, each tank column 16 extends into the body volume 17 and connects, for example, portions of the inner face 18 of the tank body 14 opposite to each other relative to the body volume 17.

Each tank column 16 is, for example, welded to the tank body 14 at each of the ends of the column 16 and/or made so as to form a single piece with the tank body 14.

Each tank column 16 is, for example, made from composite. The composite from which each tank column 16 is made comprises, for example, a resin such as: an epoxy resin, or a resin made from at least one thermoplastic polymer selected from the group consisting of polyolefins, in particular polypropylene, polyamides, in particular aliphatic polyamides, such as polycaprolactam PA 6, polyhexamethylene adipamide PA 6.6, polycarbonates, PAEK (polyaryletherketone), including PEEK (polyetheretherketone) and PEKK (polyetherketoneketone), acrylic-based materials such as PMMA (including the resin known as ELIUM), PEI (Polyetherimide also known as ULTEM), PPS (Polyphenylene Sulfide), ABS (Acrylonitrile Butadiene Styrene), PLA (Polylactic Acid), TPU (Thermoplastic Polyurethane) and PET (Polyethylene), and mixtures thereof.

The composite from which each tank column 16 is made comprises, for example, a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers.

In a particular embodiment, the material of the reservoir columns 16 is the same as the material of the tank body 14.

As shown in FIG. 2, each tank column 16 is, for example, hollow.

As seen above, the liner 12 is, for example, arranged in the body volume 17.

The liner 12 is configured to ensure that the tank 10 is leaktight to the pressurized gas while the tank body 14 is configured to ensure that the pressurized gas is pressure-resistant. part 24.

As shown in FIG. 2, the liner comprises a first part 22 and a second part 24.

The first part 22 and the second part 24 are, for example, made of a thermoplastic material chosen from the list consisting of ABS (Acrylonitrile butadiene styrene), PA (polyamide), PC (polycarbonate), PP (polypropene), PMMA (polymethyl methacrylate), PS (Expanded Polystyrene), PBT (butylene terephthalate). The material of the first part 22 and the second part 24, is for example more particularly chosen from the list consisting of: PA6 (Polycaprolactam), PA11 (polyundecanamide) or PA12 (Nylon 12).

As will be described in more detail below, the thermoplastic material chosen to form the first part 22 or the second part 24 may, for example, comprise an additive.

The first part 22 comprises a first shell 26 and at least one pillar 28. As shown in FIGS. 1 and 2, the first part 22 comprises, for example, a plurality of pillars 28 and for example at least four pillars 28.

The second part 24 comprises a second shell 30 and comprises, for example, a receiving seat 31. As shown in FIGS. 1 and 2, the second part 24 comprises, for example, a plurality of receiving seats 31 and for example as many receiving seats 31 as pillars 28.

As shown in FIGS. 1 and 2, the first shell 26 comprises a first peripheral edge 32 and an inner face 33. The first shell 26, and more particularly the inner face 33, delimits a first concave space 34, open along the first peripheral edge 32. As will be described in more detail below, the first shell 26 comprises, for example, an orifice 35 in which the pillar 28 is housed.

As shown in FIGS. 1 and 2, the second shell 30 comprises a second peripheral edge 36 and an inner face 38. The second shell 30, and more particularly the inner face 38, delimits a second concave space 39, open along the second peripheral edge 36. As will be described in more detail below, the second shell 30 comprises, for example, an orifice 40 in which the receiving seat 31 is housed.

The first part 22 and the second part 24 are arranged facing each other, the first concave space 34 and the second concave space 39 opening out, for example, facing one another.

The first peripheral edge 32 is in particular arranged opposite the second peripheral edge 36 and the first peripheral edge 32 is rigidly connected to the second peripheral edge 36. The first shell 26 and the second shell 30 thus rigidly connected by the first 30 and the second 36 peripheral edges delimit between them an interior volume 41. The interior volume 41 thus delimited is configured to be occupied by the pressurized gas.

As shown in FIGS. 1 to 4, at least one port 42 of the tank 10 is, for example, housed in the first part 22 to allow access to the interior volume 41, for example for filling the interior volume 41 with pressurized gas and/or emptying it of same.

One of the first 32 and second 36 peripheral edges extends around the other of the first 32 and second 36 peripheral edges into an overlapping region 43.

In particular, as shown in FIG. 2, the second peripheral edge 36 extends, for example, around the first peripheral edge 32 and is affixed to the first peripheral edge 32 on the side opposite the interior volume 41. To this end, the first peripheral edge 32 comprises an overlapped portion 44 and the second peripheral edge 36 comprises an overlapping portion 45. As shown in FIG. 2, the overlapped portion 44 for example forms a tongue protruding over the overlapping portion 45.

As shown in FIG. 1, the first peripheral edge 32 and the second peripheral edge 36 are rigidly connected in a junction plane J. It will be understood in particular that at least 50% of the first peripheral edge 32 and the second peripheral edge 36 are rigidly connected along the junction plane J. As shown in FIG. 2, it will also be understood that the first peripheral edge 32 and second peripheral edge 36 are, for example, rigidly connected outside the junction plane, for example when said peripheral edges 32, 36 extend in the vicinity of the port 42 and that the peripheral edges 32, 36 are offset from the junction plane J.

The at least one pillar 28 passes through the interior volume 41. In particular, the at least one pillar 28 passes through the interior volume 41 so that the interior volume 41 extends around the pillar 28, between the first shell 26 and the second shell 30.

As can be seen in FIGS. 1 and 2, the pillar further passes through the junction plane J. The pillar 28 is, for example, orthogonal to the junction plane J.

As shown in FIGS. 1 and 2, the pillar 28 and the first shell 26 are integral. The pillar 28 and the first shell 26 are in other words formed in a single part, the at least one pillar 28 and the first shell 26 forming the first part 22 being, for example, molded in a single piece.

The pillar 28 comprises a proximal end 46 and a distal end 47. As shown in FIGS. 1 and 2, the pillar 28 is elongated in an elongation direction X-X′ between its proximal end 46 and its distal end 47.

As shown in FIGS. 1 and 2, the proximal end 46 is connected to the first shell 26. The distal end 47 is rigidly connected to the second part 24 and, for example, to the second shell 26 and/or to the receiving seat 31.

A cross-section of the pillar 28 decreases from its proximal end 46 to its distal end 47, for example all along the pillar 28 along its direction of elongation X-X′. A cross-section of the pillar 28 comprises an outer section of the pillar, defining, for example, the interior volume 41, measured orthogonally to the direction of elongation X-X′.

As shown in FIG. 1, the pillar comprises, for example, a pillar neck 48 and a pillar body 50, the neck 48 of the pillar connecting the body of the pillar to the first shell 26. In particular, the pillar neck 48 connects the pillar to the first shell 26 in the orifice 35 of the first shell 26.

In the embodiment shown in FIGS. 1 and 2, the transverse cross-section of the pillar is substantially circular. The pillar body 50 is then, for example, frustoconical in shape, the section of the pillar 28 thus minimum at the distal end 47 of the pillar 28.

In a variant not shown, the cross-section of the pillar is substantially ellipsoidal.

As shown in FIG. 2, the pillar 28 is, for example, hollow. In such a case, the pillar comprises a pillar wall 52, connected to the first shell 26 and delimiting a pillar cavity 54.

As shown in FIG. 2, the pillar wall 52 forms, for example, the pillar neck 48 and the pillar body 50.

The pillar wall 52 extends, for example, in the continuity of the first shell 26, that is, for example, the pillar wall 52 and a wall defining the first shell 26 do not form any sharp corners. In such a case, a thickness of the pillar wall 52 is, for example, substantially equal to a thickness of the first shell 26.

As shown in FIG. 2, the first shell 26 and the pillar 28 delimit a first opening 56 emptying into the pillar cavity 54. The first opening 56 extends in particular to the distal end 47 of the pillar 28, at the junction between the pillar 28 and the first shell 26.

As shown in FIG. 2, the second shell 30 and the pillar 28 delimit, for example, a second opening 58 emptying into the pillar cavity 54, opposite the first opening 56 relative to the pillar 28. To this end, the pillar 28 is open at its distal end 47 and the second shell 30, as well as, for example, the receiving seat 31, are for example open facing the distal end 47 of the pillar 28, to form the second opening 58.

As shown in FIG. 2, a tank column 16 is housed in the cavity 54 of each pillar 28, the tank column 16 protruding from the cavity 54 on either side of the liner 12 through the first opening 56 and the second opening 58.

As can be seen in FIG. 2, the receiving seat 31 is carried by the second shell 30. The seat 31 and the second shell 30 are, for example, integral.

The pillar is, for example, received in the receiving seat 31 and rigidly connected to the second part 24 by the receiving seat 31.

As seen above, the receiving seat 31 is, for example, open facing the distal end 47 to form the second opening 58.

The receiving seat 31 further comprises a stop portion 60 in a protruding portion 62.

The stop portion 60 is, for example, arranged opposite the distal end 47 of the pillar 28, the pillar 28 being, for example, abutting the stop portion 60 along the elongation direction X-X′.

The protruding portion 62 protrudes from the second shell 30 toward the first part 22 along the direction of elongation X-X′, the protruding portion 62 being arranged around the distal end 47.

In the example shown in FIGS. 1 and 2, the first part 22 is made of a material configured to absorb laser radiation. The second part 24 is further made of a material configured to be transparent to laser radiation.

The material configured to be transparent to laser radiation is, for example, made of one of the thermoplastic materials presented above, said thermoplastic material being free of light absorption additive.

The material configured to absorb laser radiation is, for example, made from one of the thermoplastic materials presented above, said thermoplastic material comprising a light absorption additive, such as carbon for example.

In a particular embodiment, the material configured to be transparent to laser radiation and the material configured to absorb laser radiation are made from the same thermoplastic material, the difference between these materials being that the material configured to absorb laser radiation is treated using a light absorption additive while the material configured to be transparent to laser radiation is not treated using such an additive.

The first peripheral edge 32 and the second peripheral edge 36 and/or the pillar 28 and the second part 24 are joined together by laser welding.

In the example shown in FIG. 2, the overlapped portion 44 and the overlapping portion 45 are then secured by laser welding, rigidly connecting the first peripheral edge 32 and the second peripheral edge 36. In this example, the distal end 47 of the pillar 28 is further rigidly connected to the receiving seat 31, in particular to the stop portion 60, by laser welding, rigidly connecting the pillar 28 and the second part 24.

A variant of the liner 12 described above will now be presented. According to this variant, the liner 12 differs from the variant previously presented by what follows. Similar elements bear the same references.

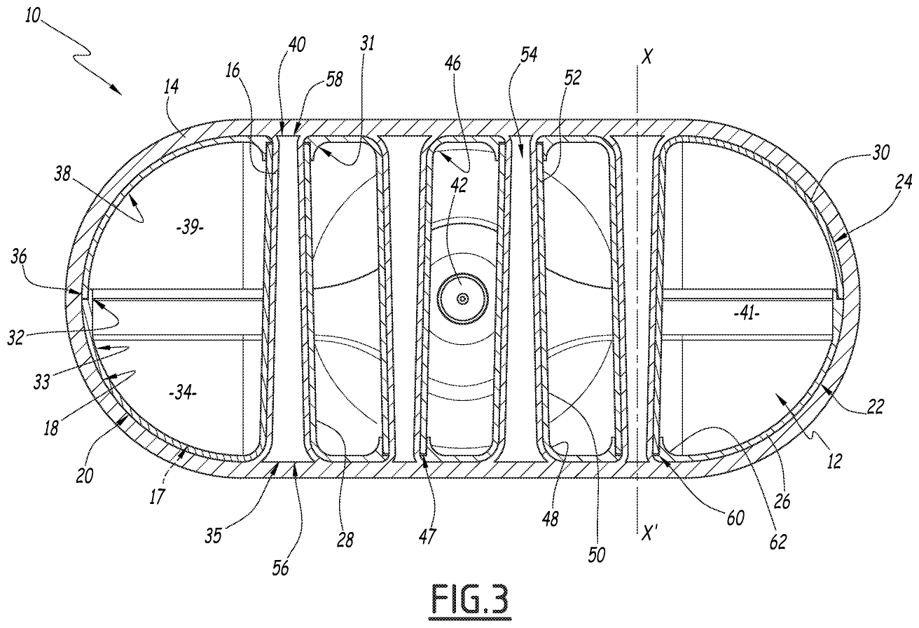

In this variant, shown in FIG. 3, the second part 24 also comprises at least one pillar 28 passing through the interior volume 41.

As shown in FIG. 3, and similarly to the at least one pillar 28 of the first part 22, the at least one pillar 28 of the second part 24 is integral with the second shell 30 and is elongated between a proximal end 46 of this pillar 28 and a distal end 47 of this pillar 28.

The proximal end 46 of the or each pillar 28 of the second part 24 is connected to the second shell 30 and the distal end 47 of the or each pillar 28 is rigidly connected to the first part 22.

As shown in FIG. 3, and similarly to the at least one pillar 28 of the first part 22, the cross-section of the pillar 28 of the second part 24 decreases from its proximal end 46 to its distal end 47.

The first part 22 further comprises, for example, according to this variant, at least one seat 31 similar to the receiving seats 31 of the second part previously presented. The pillar 28 of the second part 24 is then received in the receiving seat 31 of the first part 22 and is rigidly connected to the first part by said receiving seat 31. In other words, the pillars 28 of the second part 24 cooperate with the receiving seats 31 of the first part 22 and the pillars 28 of the first part 22 cooperate with the receiving seats 31 of the second part 24.

In this variant, and as shown in FIG. 3, the first 22 and the second 24 parts are, for example, substantially of the same shape. In particular, the first 22 and the second 24 part comprise a same number of pillars 28 arranged in the same regions of the first 26 and second 30 shells. The first 22 and second part 24 further comprise, for example, the same number of receiving seats 31 arranged in the same regions of the first 26 and second 30 shells.

As shown in FIG. 3, adjacent pillars 28 of the liner 12 are, for example, alternating pillars of the first part 22 and the second part 24, for example so that the second part 24 is of a shape analogous to the first part 22 and is reversed on the first part 22 to form the liner.

A second embodiment of a pressurized gas containment liner 12, alternative to the variants of the embodiment presented above, will now be presented. According to this second embodiment, the liner 12 differs from the embodiment presented above. Similar elements bear the same references.

In this embodiment, the first peripheral edge 32 and the second peripheral edge 36 and/or the pillar 28 and the second part 24 are not rigidly connected to each other by laser welding but are rigidly connected together by butt welding.

To this end, the first part 22 is not necessarily made of a material absorbing laser radiation and the second part 24 is not necessarily made of a material transparent to laser radiation.

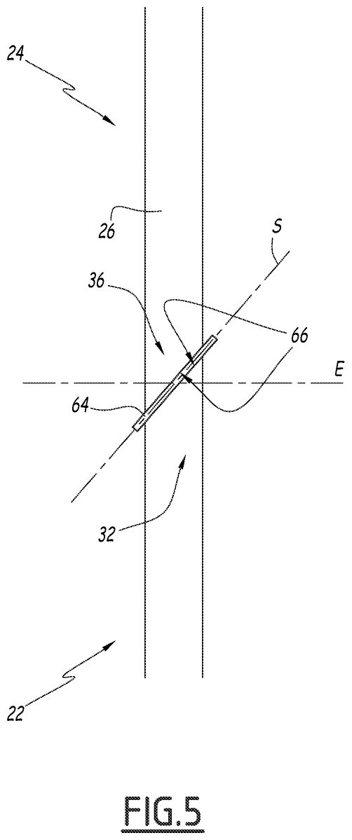

In this embodiment, and as shown in FIG. 5, at least one resistive sheet 64 is arranged between adjacent edges 66 of the first part 22 and the second part 24.

As shown in FIG. 5, a resistive sheet 64 is, for example, arranged between adjacent edges 66 welded to the first peripheral edge 32 and the second peripheral edge 36. Alternatively, or additionally, a resistive sheet is arranged between adjacent edges of the pillar 28 and the second part 24, and, for example, between the distal end 47 of the pillar 28 and the stop portion 60 of the receiving seat 31.

In the example of FIG. 5, the adjacent edges 66 delimit between them a butt welding plane S. The butt welding plane S is, for example, oblique relative to a direction of thickness E of the first peripheral edge 32 and of the second peripheral edge 36 and/or of the pillar 28 and of the second welded part 24.

In FIG. 5, where the butt-welded first peripheral edge 32 and the second peripheral edge 36 are shown, the thickness direction is substantially perpendicular to the inner faces 33, 38. The welding plane is thus not parallel to the direction of thickness E. The welding plane forms, for example, an angle of between 0° and 80° relative to the direction of thickness E and in particular between 30° and 60°.

A third embodiment of a liner 12 for compressing pressurized gas will now be presented. According to this third embodiment, the liner 12 differs from the embodiments presented above. Similar elements bear the same references.

In this third embodiment, the first part 22 and the second part 24 are neither secured by laser welding, nor by butt welding, but are secured by hot gas welding.

To this end, the first part 22 is not necessarily made of a material absorbing laser radiation and the second part 24 is not necessarily made of a material transparent to laser radiation. No resistive sheet 64 is also used to rigidly connect the first part 22 and the second part 24. Adjacent and/or superimposed edges of the first part 22 and the first part 24 are, in this embodiment, welded by the local heating of these edges using a hot gas such as hot air.

A method for manufacturing a pressurized gas containment liner 12 as described above will now be presented.

During a first step, the first part 22 and the second part 24 are provided.

During a second step, the first peripheral edge 32 is rigidly connected to the second peripheral edge 36 and the pillar 28 is rigidly connected to the second part 24.

According to the first embodiment presented above, the first peripheral edge 32 and the second peripheral edge 36 as well as the pillar 28 and the second part 24 are rigidly connected by laser welding.

To this end, a laser beam is pointed on the first peripheral edge 32, absorbing the laser beam, through the second peripheral edge 36, transparent to the laser beam. The local heating of the first peripheral edge 32 associated with the absorption of the laser beam causes local melting of the first peripheral edge 32 as well as local melting of the second peripheral edge 36 being adjacent thereto, resulting in the fastening by laser welding of the first 32 and the second 36 peripheral edges.

Similarly, a laser beam is pointed on the pillar 28 through the second part 24 for the fastening by laser welding of the pillar 28 and of the second part 24.

According to the second embodiment presented above, the rigid connection of the first peripheral edge 32 to the second peripheral edge 36 and the rigid connection of the pillar 28 to the second part 24 is carried out by butt welding.

The resistive sheet 64 is arranged between the adjacent edges 66 of the first part 22 and the second part 24. A current is then generated through the resistive sheet 64 for its heating by the Joule effect. The adjacent edges 66 are thus heated, resulting in the adjacent edges 66 being welded to the resistive sheet 64.

According to the third embodiment presented above, the rigid connection of the first peripheral edge 32 to the second peripheral edge 36 and the rigid connection of the pillar 28 to the second part 24 is carried out by hot gas welding.

The heating of adjacent parts for their local melting and for the resulting weld is then carried out by way of a hot gas jet.

It will be understood that the various welding modes presented in the three above embodiments can be combined and are, for example, interchangeable. For example, the first peripheral edge 32 is welded to the second peripheral edge 36 by butt welding and the pillar 28 is welded to the second part 24 by laser welding.

The disclosure has been shown and described in detail in the drawings and the preceding description. This must be considered as illustrative and given by way of example and not as limiting the disclosure to this only description. Many alternative embodiments are possible.

1. A pressurized gas containment liner, comprising:
a first part, comprising a first shell comprising a first peripheral edge;
a second part, comprising a second shell comprising a second peripheral edge; and
the first peripheral edge being rigidly connected to the second peripheral edge, the first shell and the second shell delimiting between them an interior volume, the first part comprising at least one pillar passing through the interior volume, formed integrally with the first shell and being elongated between a proximal end, connected to the first shell, and a distal end, rigidly connected to the second part, a transverse section of the at least one pillar decreasing from the proximal end to the distal end.

2. The pressurized gas containment liner according to claim 1, wherein the at least one pillar is hollow, the at least one pillar comprising a pillar wall connected to the first shell and delimiting a pillar cavity.

3. The pressurized gas containment liner according to claim 2, wherein the pillar wall extends in a continuity of the first shell, the first shell and the at least one pillar delimiting a first opening emptying into the pillar cavity, the second shell and the at least one pillar delimiting a second opening opposite the first opening relative to the at least one pillar, the second opening emptying into the pillar cavity.

4. The pressurized gas containment liner according to claim 2, wherein a thickness of the pillar wall is substantially equal to a thickness of the first shell.

5. The pressurized gas containment liner according to claim 1, wherein the first peripheral edge is rigidly connected to the second peripheral edge along a junction plane, the at least one pillar passing through the junction plane.

6. The pressurized gas containment liner according to claim 1, wherein the second part comprises at least one receiving seat, carried by the second shell, the at least one pillar being received in the at least one receiving seat and rigidly connected to the second part by the at least one receiving seat.

7. The pressurized gas containment liner according to claim 1, wherein one of the first peripheral edge and the second peripheral edge extends around the other of the first peripheral edge and the second peripheral edge into an overlapping region.

8. The pressurized gas containment liner according to claim 1, wherein one of the first part and the second part is formed of a material configured to be transparent to laser radiation, the other of the first part and the second part being formed of a material configured to absorb the laser radiation, the first peripheral edge and the second peripheral edge and/or the at least one pillar and the second part being rigidly connected to each other by laser welding.

9. The pressurized gas containment liner according to claim 1, wherein the first peripheral edge and the second peripheral edge and/or the at least one pillar and the second part are rigidly connected together by butt welding, a resistive sheet being arranged between welded adjacent edges of the first peripheral edge and the second peripheral edge and/or the at least one pillar and the second part.

10. The pressurized gas containment liner according to claim 9, wherein the welded adjacent edges together delimit an oblique edge butt welding plane extending obliquely relative to a direction of thickness of the first peripheral edge and the second peripheral edge and/or the at least one pillar and second welded part.

11. The pressurized gas containment liner according to claim 1, wherein the second part comprises at least one pillar passing through the interior volume, formed integrally with the second shell and being elongated between a proximal end, connected to the second shell, and a distal end, rigidly connected to the first part, a cross-section of the at least one pillar decreasing from the proximal end to the distal end.

12. The pressurized gas containment liner according to claim 11, wherein the first part and the second part are substantially of the same shape.

13. A pressurized gas tank comprising a pressurized gas containment liner according to claim 1, and a tank body arranged around the pressurized gas containment liner, an inner face of the tank body being affixed to an outer face of the pressurized gas containment liner.

14. A method for manufacturing a pressurized gas containment liner according to claim 1, comprising the following steps:
providing a first part and a second part of the pressurized gas containment liner;
rigidly connecting the first peripheral edge to the second peripheral edge and rigidly connecting the at least one pillar of the first part to the second part.
